(19) United States
(12) Patent Application Publication
(10) Pub. No.: US 2025/0072656 A1
(43) Pub. Date: Mar. 6, 2025

(54) EMPTY PUMPING PREVENTION APPARATUS AND METHOD

(71) Applicant: Tsann Kuen (Zhangzhou) Enterprise Co., Ltd., Zhangzhou City (CN)

(72) Inventors: Yousheng CHEN, Zhangzhou City (CN); Yafei HAN, Zhangzhou City (CN)

(21) Appl. No.: 18/806,770

(22) Filed: Aug. 16, 2024

(30) Foreign Application Priority Data
Sep. 4, 2023 (CN) 202311129752.3

(51) Int. Cl. A47J 31/56; A47J 31/52; A47J 31/58; F24H 1/18; F24H 15/223; F24H 15/248; F24H 15/335

(52) U.S. Cl. CPC A47J 31/56; A47J 31/5253; A47J 31/58; F24H 1/185; F24H 15/223; F24H 15/248; F24H 15/335

(57) ABSTRACT

The present disclosure discloses an empty pumping prevention apparatus. A bottom of a water tank is provided with a water outlet, and a temperature sensor is provided proximate the water outlet. After a heater stops heating, a water pumping action is performed; during operation of a water pump, temperature data collected by the temperature sensor is continuously read, and a current slope of temperature drop is calculated; then it is determined whether there is water based on a value of the current slope of temperature drop; and the water pump stops operating when it is determined that there is no water in the water tank.

### CROSS-REFERENCE TO RELATED APPLICATIONS

This application claims priority to Chinese Patent Application 202311129752.3, filed on Sep. 4, 2023, which is incorporated herein by reference.

### TECHNICAL FIELD

The present disclosure relates to the technical field of liquid heating, in particular to an empty pumping prevention apparatus and method.

### BACKGROUND

A heating plate, a negative temperature coefficient (NTC) temperature sensor and a water outlet are provided at the bottom of a water tank of a coffee machine. During operation, the coffee machine heats water to a preset temperature and then stops heating and starts pumping water to extract coffee. When the water tank is heated to the preset temperature, the amount of water in the water tank will be calculated, and the pumping time of a water pump is set according to the calculated amount of water. Due to the impact of the ambient temperature and the difference in heating plate, the determined amount of water may be inaccurate, so there may be a situation that the water pump is still operating though all water in the water tank has been pumped out, which accordingly results in noise and leads to poor user experience.

The coffee machine may also detect whether there is water using flowmeters, Hall sensors and other ways, but the use of these sensors will greatly increase the complexity and cost of the machine.

### SUMMARY

In view of the above defects of the prior art, the purpose of the present disclosure is to provide an empty pumping prevention apparatus, which can determine whether there is water without changing the structure or additionally providing a flowmeter, a Hall sensor and other sensors, so as to control a water pump to stop operating in time.

In order to achieve the above purpose, the present disclosure provides an empty pumping prevention apparatus. The empty pumping prevention apparatus includes a water tank, a water pump, a heater, a temperature sensor and a controller;
a bottom of the water tank is provided with a water outlet, and the temperature sensor is provided at the bottom of the water tank and proximate the water outlet; and

the controller is connected to the temperature sensor, the water pump and the heater for
controlling the heater to perform heating;
controlling, after the heater stops heating, the water pump to operate to perform a water pumping action;
continuously reading, during operation of the water pump, temperature data collected by the temperature sensor, and calculating a current slope of temperature drop at the water outlet; then determining whether there is water based on a value of the current slope of temperature drop at the water outlet; and stopping the water pump from operating when it is determined that there is no water in the water tank.

Further, the heater is a heating plate or a heating tube attached to an outer side of the bottom of the water tank.

Further, the heater is a heating plate and forms a part of the bottom of the water tank.

Further, the temperature sensor is an NTC temperature sensor.

Further, a distance between the temperature sensor and the water outlet is not greater than 30 mm.

Further, a diversion apparatus is provided at the water outlet, and the temperature sensor is provided proximate a diversion opening of the diversion apparatus.

Further, a distance between the temperature sensor and the water outlet is not greater than 50 mm.

Further, devices to which the empty pumping prevention apparatus is applied include a coffee machine and a water dispenser.

The present disclosure further provides an empty pumping prevention method which is applied to an empty pumping prevention apparatus. The empty pumping prevention apparatus includes a water tank, a water pump, a heater, a temperature sensor and a controller, a bottom of the water tank is provided with a water outlet, the temperature sensor is provided at the bottom of the water tank and proximate the water outlet, and

the controller is connected to the temperature sensor, the water pump and the heater for:
heating, before operation of the water pump, water in the water tank to a preset temperature;
continuously reading, during the operation of the water pump, temperature data collected by the temperature sensor, and calculating a current slope of temperature drop at the water outlet; and
determining whether there is water based on a value of the current slope of temperature drop at the water outlet, and stopping the water pump from operating when it is determined that there is no water in the water tank.

The present disclosure achieves the following beneficial effects:

According to the empty pumping prevention apparatus, the temperature of the water outlet is detected through the temperature sensor, which can determine whether there is water without changing the structure or additionally providing a flowmeter, a Hall sensor and other sensors, so as to rapidly stop the water pump from operating, and avoid the problem of noisy sound and poor user experience caused by too long time of empty pumping without water.

### BRIEF DESCRIPTION OF DRAWINGS

FIG. 1 is a system sketch of an empty pumping prevention control system for a coffee machine.

FIG. 2 is a schematic diagram of installation positions of a heating plate and an NTC temperature sensor according to one embodiment.

FIG. 3 is a schematic diagram of an installation elevation of a water tank, a heating plate, and an NTC temperature sensor of a coffee machine according to one embodiment.

FIG. 4 is a schematic diagram of an installation elevation of a water tank, a heating plate, and an NTC temperature sensor of a coffee machine according to another embodiment.

FIG. 5 is a temperature-time graph of natural cooling of an NTC temperature sensor in the case where the NTC temperature sensor is not provided near a water outlet.

FIG. 6 is a temperature-time graph of rapid cooling of an NTC temperature sensor under the influence of pumping airflow in the case where the NTC temperature sensor is provided near a water outlet.

FIG. 7 is a schematic diagram of a position of a diversion apparatus according to one embodiment.

### DESCRIPTION OF EMBODIMENTS

To further illustrate the embodiments, the present disclosure is provided with accompanying drawings. The accompanying drawings, which constitute a part of the disclosure of the present disclosure, are mainly intended to illustrate the embodiments, and may, together with relevant description of the specification, serve to explain the principles of operation of the embodiments. With these references in mind, a person of ordinary skill in the art will appreciate other possible implementations and advantages of the present disclosure.

The present disclosure will now be further illustrated with reference to the accompanying drawings and the detailed description.

### Embodiment 1

This embodiment provides an empty pumping prevention apparatus, which is specifically an electric coffee machine.

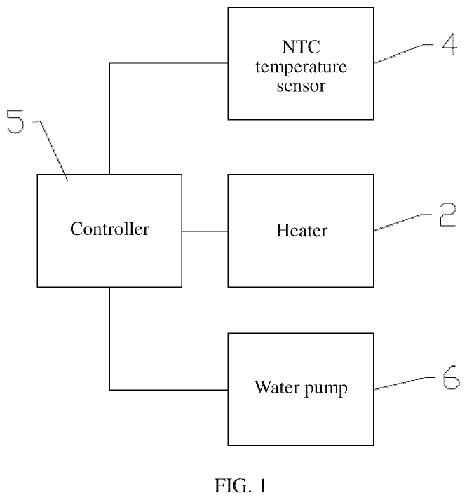

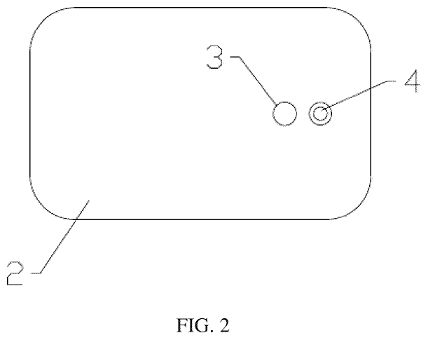

As shown in FIG. 1 to FIG. 4, this embodiment provides an example of an empty pumping prevention system for a coffee machine. In this embodiment, a water outlet 3 is provided in a bottom of a water tank 1 of the coffee machine, and a heater 2, an NTC temperature sensor 4, and other components are installed at the bottom of the water tank 1. The water outlet 3 is connected to a water pump 6 through a plastic pipeline or metal pipeline. The heater 2, the NTC temperature sensor 4 and the water pump 6 are connected to a controller 5 (control panel) of the coffee machine. The controller 5 monitors the temperature of water in the water tank 1 through the NTC temperature sensor 4, controls the heater 2 to perform heating, and controls the water pump 6 to pump water after the heater 2 stops heating.

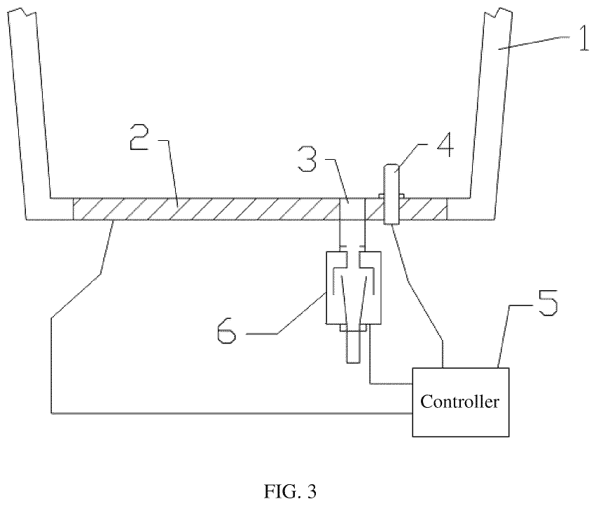

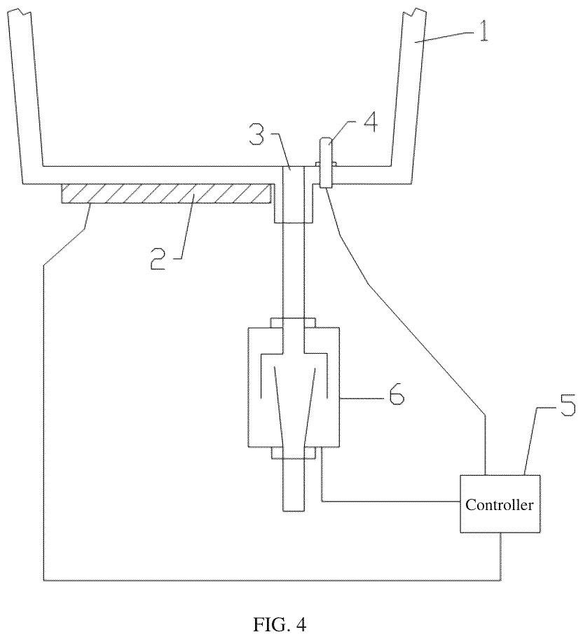

In specific implementation, the heater 2 is a heating plate or heating tube, which may be attached to an outer side of the bottom of the water tank 1 (as shown in FIG. 4) or directly forms a part of the bottom of the water tank 1 (as shown in FIG. 3).

In this embodiment, the installation position of the NTC temperature sensor 4 is constrained: as shown in FIG. 3 and FIG. 4, the NTC temperature sensor 4 is installed at the bottom of the water tank 1 and is provided on one side of the water outlet 3 of the water tank 1 at a close distance. When the coffee machine is in use, the steps of heating water and pumping water to extract coffee after stopping heating are included.

When completing the step of pumping water to extract coffee, the coffee machine may evacuate water in the water tank 1. At this time, after the water pump 6 evacuates the water, air around the NTC temperature sensor 4 may be driven to flow, and air pumping may accelerate the change of air temperature around the NTC temperature sensor 4. Therefore, sensing of the temperature change by the NTC temperature sensor 4 may be accelerated through the airflow at the water outlet near the NTC temperature sensor 4, so that it is accurately determined whether the water in the water tank 1 is evacuated.

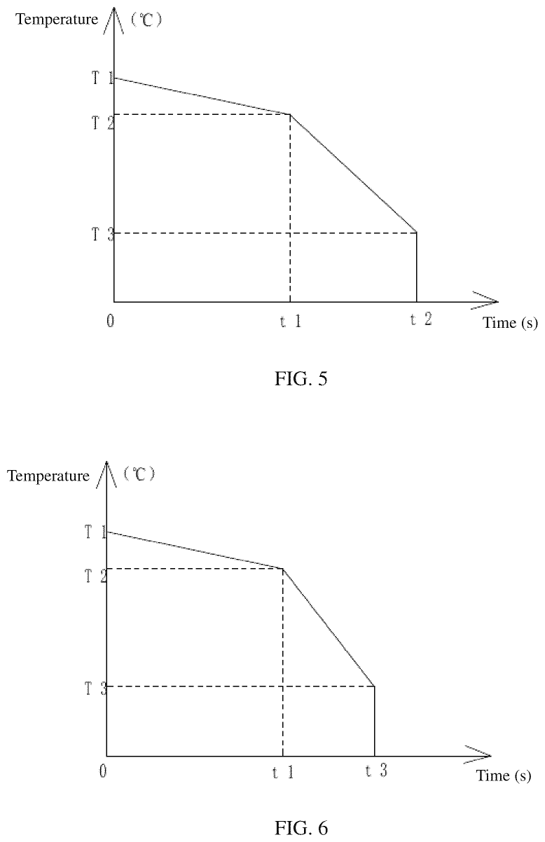

FIG. 5 is a temperature-time graph of natural cooling of the NTC temperature sensor 4 in the case where the NTC temperature sensor 4 is not provided near the water outlet 3. T1 denotes the highest temperature after water heating stops; T2 denotes the temperature at which the NTC temperature sensor 4 starts to be exposed to air after water is evacuated; 0-t1 denotes the time period when the NTC temperature sensor 4 is in the water before the water in the water tank is evacuated; t1 denotes the time when the NTC temperature sensor 4 starts to be exposed to air; and t2 denotes the time when the NTC temperature sensor 4 drops to the temperature T3 (natural cooling).

FIG. 6 is a temperature-time graph of rapid cooling of the NTC temperature sensor 4 under the influence of pumping airflow in the case where the NTC temperature sensor 4 is provided near the water outlet 3. 0-t1 denotes the time period when NTC temperature sensor 4 is in water before water in the water tank 1 is all pumped out; t1 denotes the time when the NTC temperature sensor 4 begins to be exposed to air; and t3 denotes the time when the NTC temperature sensor 4 drops to the temperature T3 (the water pump 6 removes air at the water outlet 3 of the water tank 1, which drives the flow cooling of air around the NTC temperature sensor 4).

It can be seen from FIG. 5 that the temperature drop rate detected when the NTC temperature sensor 4 is exposed to air for natural cooling is greater than that detected when the temperature sensor is in water. It can be seen from FIG. 6 that the cooling rate obtained when the NTC temperature sensor 4 is exposed to air and the water pump 6 removes air around the NTC temperature sensor 4 may be greater than that obtained during normal exposure to natural cooling.

It can be seen that from when there is water in the water tank 1 to when there is no water in the water tank 1, no matter where the NTC temperature sensor 4 is provided at the bottom of the water tank 1, the value change of temperature drop in the water tank 1 over time may be detected. However, in the case where the NTC temperature sensor 4 is provided away from the water outlet 3, the NTC temperature sensor 4 begins to be exposed to air and is cooled naturally without being affected by the airflow at the water outlet 3, but due to the high chamber temperature, the temperature drop around the NTC temperature sensor 4 is too slow to detect the temperature change in a short time. On the contrary, in the case where the NTC temperature sensor 4 is provided near the water outlet 3, the obtained temperature-time curve of the water outlet 3 may have a very obvious change in slope value (the temperature drops faster and the slope value is larger when there is no water). By recording and monitoring the temperature-time curve of the water outlet 3 during water pumping of the water pump 6, and calculating the slope value of the temperature-time curve, it may be determined, in a shorter time, whether the water in the water tank 1 is all pumped out based on the interval in which the slope value is located.

When it is determined that the water in the water tank 1 has been all pumped out (that is, the water pump 6 is in an evacuation state), the water pump 6 stops operating.

In addition to the coffee machine, the empty pumping prevention apparatus of this embodiment may also be applied to liquid heating devices such as a water dispenser. It may be determined whether there is water without changing the structure of the device or additionally providing a flowmeter, a Hall sensor, and other sensors, and the water pump 6 rapidly stops operating when the water pump 6 evacuates water. Thus, the problems of noisy sound and poor user experience caused by a long time of empty pumping without water are avoided.

In this embodiment, in order to ensure that when the water pump 6 evacuates water, the temperature change around temperature sensor 4 may be effectively affected, the negative temperature coefficient (NTC) temperature sensor 4 needs to be provided near the water outlet 3 of the water tank 1. The distance between the negative temperature coefficient (NTC) temperature sensor 4 and the water outlet 3 may be set as required. Preferably, the distance between the negative temperature coefficient (NTC) temperature sensor 4 and the water outlet 3 is not greater than 30 mm.

In this embodiment, the water outlet 3 is a 360° omnidirectional water outlet, and no matter which side of the water outlet 3 the negative temperature coefficient (NTC) temperature sensor 4 is located on, the temperature sensor may be affected by liquid flow or airflow at the water outlet 3.

### Embodiment 2

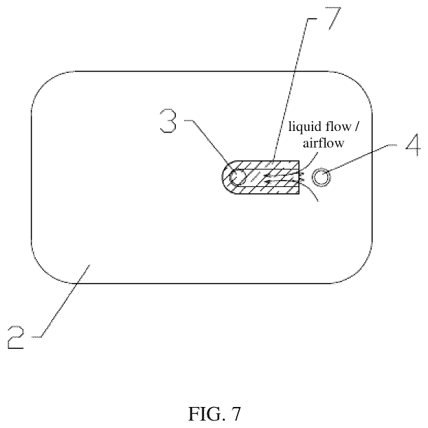

As shown in FIG. 7, in the specific application, a diversion apparatus 7 (a diversion tank, a diversion cover, etc.) may be provided at the water outlet 3 for diversion, and the negative temperature coefficient (NTC) temperature sensor 4 is provided near a diversion opening of the diversion apparatus 7, so discharged water may pass through the negative temperature coefficient (NTC) temperature sensor 4. Moreover, in the process from when there is water in the water tank 1 to when there is no water in the water tank, airflow passing through the negative temperature coefficient (NTC) temperature sensor 4 may be more concentrated, and the temperature drop of the negative temperature coefficient (NTC) temperature sensor 4 is faster when the water pump 6 evacuates the water. In this way, the limit to the distance between the negative temperature coefficient (NTC) temperature sensor 4 and the water outlet 3 may be relaxed. Preferably, the distance between the negative temperature coefficient (NTC) temperature sensor 4 and the water outlet 3 is not greater than 50 mm.

In the above embodiments, the temperature sensor is a temperature sensor which may measure temperature quickly and in real time, such as the negative temperature coefficient (NTC) temperature sensor 4. The resistance value of the negative temperature coefficient (NTC) temperature sensor 4 decreases rapidly with the increase of temperature, so the temperature sensor may quickly collect temperature and reflect the temperature change in real time. Thus, it is ensured that the controller 5 stops the action of the water pump 6 in time when detecting out that there is no water in the water tank 1.

The present disclosure further provides an empty pumping prevention method. The method includes:
a temperature sensor (a negative temperature coefficient (NTC) temperature sensor 4 in this embodiment) is provided proximate a water outlet 3 of a water tank 1;
before operation of a water pump 6, water in the water tank 1 is heated to a preset temperature;
during the operation of the water pump 6, temperature data of the water outlet 3 of the water tank 1 collected by the temperature sensor is continuously read, and a current slope of temperature drop is calculated; and
it is determined whether there is water based on a value of the slope of temperature drop, and the water pump 6 stops operating when it is determined that there is no water in the water tank 1.

While the present disclosure has been particularly illustrated and described with references to the preferred embodiments, it will be understood by a person skilled in the art that all changes in form and details made to the present disclosure without departing from the spirit and scope of the present disclosure as defined by the appended claims fall within the scope of protection of the present disclosure.

1. An empty pumping prevention apparatus, comprising a water tank, a water pump, a heater, a temperature sensor and a controller;
a bottom of the water tank is provided with a water outlet, and the temperature sensor is provided at the bottom of the water tank and proximate the water outlet; and
the controller is connected to the temperature sensor, the water pump, and the heater for controlling the heater to perform heating;
controlling, after the heater stops heating, the water pump to operate to perform a water pumping action;
continuously reading, during operation of the water pump, temperature data collected by the temperature sensor, and calculating a current slope of temperature drop at the water outlet; then determining whether there is water based on a value of the current slope of temperature drop at the water outlet; and stopping the water pump from operating when it is determined that there is no water in the water tank.

2. The empty pumping prevention apparatus according to claim 1, wherein the heater is a heating tube or a heating plate attached to an outer side of the bottom of the water tank.

3. The empty pumping prevention apparatus according to claim 1, wherein the heater is a heating plate and forms a part of the bottom of the water tank.

4. The empty pumping prevention apparatus according to claim 1, wherein the temperature sensor is a negative temperature coefficient (NTC) temperature sensor.

5. The empty pumping prevention apparatus according to claim 1, wherein a distance between the temperature sensor and the water outlet is not greater than 30 mm.

6. The empty pumping prevention apparatus according to claim 1, wherein a diversion apparatus is provided at the water outlet, and the temperature sensor is provided proximate a diversion opening of the diversion apparatus.

7. The empty pumping prevention apparatus according to claim 6, wherein a distance between the temperature sensor and the water outlet is not greater than 50 mm.

8. The empty pumping prevention apparatus according to claim 1, wherein devices to which the empty pumping prevention apparatus is applied comprise a coffee machine and a water dispenser.

9. The empty pumping prevention apparatus according to claim 2, wherein devices to which the empty pumping prevention apparatus is applied comprise a coffee machine and a water dispenser.

10. The empty pumping prevention apparatus according to claim 3, wherein devices to which the empty pumping prevention apparatus is applied comprise a coffee machine and a water dispenser.

11. The empty pumping prevention apparatus according to claim 4, wherein devices to which the empty pumping prevention apparatus is applied comprise a coffee machine and a water dispenser.

12. The empty pumping prevention apparatus according to claim 5, wherein devices to which the empty pumping prevention apparatus is applied comprise a coffee machine and a water dispenser.

13. The empty pumping prevention apparatus according to claim 6, wherein devices to which the empty pumping prevention apparatus is applied comprise a coffee machine and a water dispenser.

14. The empty pumping prevention apparatus according to claim 7, wherein devices to which the empty pumping prevention apparatus is applied comprise a coffee machine and a water dispenser.

15. An empty pumping prevention method, wherein the empty pumping prevention method is applied to an empty pumping prevention apparatus, the empty pumping prevention apparatus comprises a water tank, a water pump, a heater, a temperature sensor and a controller, a bottom of the water tank is provided with a water outlet, the temperature sensor is provided at the bottom of the water tank and proximate the water outlet, and the controller is connected to the temperature sensor, the water pump and the heater for:
heating, before operation of the water pump, water in the water tank to a preset temperature;
continuously reading, during the operation of the water pump, temperature data collected by the temperature sensor, and calculating a current slope of temperature drop at the water outlet; and
determining whether there is water based on a value of the current slope of temperature drop at the water outlet, and stopping the water pump from operating when it is determined that there is no water in the water tank.
